(19) United States
(12) Patent Application Publication
(10) Pub. No.: US 2010/0174217 A1
(43) Pub. Date: Jul. 8, 2010

(54) POINT VIBRATION THERAPY DEVICE

(76) Inventors: Mark M. Budnik, Valparaiso, IN (US); G. Scott Duncan, Valparaiso, IN (US); Angela S. Vernon, LaCrosse, IN (US)

Correspondence Address: PASKY INTELLECTUAL PROPERTY LAW LLC, 100 FOREST PLACE, SUITE 810, OAK PARK, IL, 60301, US

(21) Appl. No.: 12/550,342

(22) Filed: Aug. 28, 2009

Related U.S. Application Data
(60) Provisional application No. 61/190,369, filed on Aug. 28, 2008.

(51) Int. Cl. A61H 1/00

(52) U.S. Cl. 601/46

(57) ABSTRACT

A point vibration therapy device (“PVTD”) is designed to provide vibration therapy or stimulation to a user to alleviate stimming behavior caused by a sensory dysfunction. The PVTD includes a control system, a power system, and a vibration source system. The control system includes a control circuit, a housing, an I/O interface and inputs for a user to interact with the device, e.g., adjusting the frequency and duration of vibrations for optimal effect on the user. The power system includes a power source and charge management controller. The vibration source system includes a vibration source, a housing, power control connections, and an attachment device to attach to a user's body. The control system, power system, and vibration source system are all interconnected and may be contained in a singular or multiple housings.

### CROSS REFERENCE TO RELATED APPLICATIONS

This application claims the benefit of U.S. Provisional Application No. 61/190,369, filed Aug. 28, 2008, which is hereby incorporated by reference in its entirety.

### BACKGROUND OF THE DISCLOSURE

1. Field of the Disclosure

The present disclosure relates generally to a device that provides vibration therapy to discrete body parts of a patient in a non-obtrusive fashion.

2. Description of the Background of the Disclosure

A large number of individuals with autism spectrum disorders experience some form of sensory dysfunction, which may be expressed as difficulty in regulating responses to sensory input, for example, over-sensitivity to repetitive sounds and under-sensitivity to painful stimuli, or as difficulty maintaining attention to stimulation. Such sensory dysfunctions can lead to stereotypical “stimming” behavior, such as spinning, flailing of limbs, banging of the head, etc., to help an individual determine the location of his/her body in space. Such stimming behavior also serves a sensory modulating function, which allows the individual to regulate his/her anxiety level when experiencing sensory stimulation.

Devices including weighted vests, pressure chambers, and full-body vibration devices have been designed to provide external stimulation in a safe, controlled manner. Additionally, general pressure and massage techniques have been developed to aid individuals with relaxation and spatial determination. Each of these devices and techniques has been shown to have a calming effect on individuals with autism spectrum disorders when in high-stress environments. Unfortunately, each of these devices suffers from one or more disadvantages. One problem, for example, is providing a constant stimulus that becomes a habit, such as with weighted vests. Further, many such devices are non-mobile or obtrusive and interfere with day-to-day activities. Still further, the cost of such devices and techniques is often very high.

It is desirable, therefore, to provide a system for vibration therapy that reduces cost, provides discretion, enables intermittent stimulation, and favorably impacts the current state of vibration therapy for sensory and neurological dysfunctions.

### SUMMARY OF THE INVENTION

In one embodiment, a point vibration therapy device is provided which includes a control system including a control circuit and a plurality of inputs, a power system including a power source, and a vibration source system including a vibration source and a plurality of power control connections. Such point vibration therapy device provides a connection between the control system, the power system, and the vibration source system.

In a further aspect, a system for point vibration therapy includes a control circuit, a plurality of inputs for a user to interact with the system, a power source, and a vibration source. The power source powers both the control circuit and the vibration source, and the control circuit controls vibrations received by a user from the vibration source.

The various features of the present invention will become more readily apparent from a consideration of the following description, to be read in conjunction with the accompanying drawings, in which like reference numerals represent same or similar items.

### BRIEF DESCRIPTION OF THE DRAWINGS

FIG. 1 illustrates a point vibration therapy device (“PVTD”) attached to a user, wherein the PVTD includes a control circuit housing and a vibration source housing;

FIG. 2A is a plan view of an embodiment of the control circuit housing of FIG. 1;

FIG. 2B is a bottom elevation view of the control circuit housing of FIG. 2A;

FIG. 2C is a left side elevation view of the control circuit housing of FIG. 2A;

FIG. 2D is a right side elevational view of the control circuit housing of FIG. 2A;

FIG. 3A is a plan view of an embodiment of the vibration source housing of FIG. 1;

FIG. 3B is a bottom elevational view of the vibration source housing of FIG. 3A;

FIG. 3C is a side elevational view of an upper portion of the vibration source housing of FIG. 3A;

FIG. 3D is a side elevational view of a bottom portion of the vibration source housing of FIG. 3A that engages with the upper portion of FIG. 3C

FIG. 4 illustrates an embodiment of a control system useable with the PVTD of FIG. 1;

FIG. 5A illustrates a battery and a charge management controller useable with the PVTD of FIG. 1;

FIG. 5B illustrates a partially exploded isometric view of an embodiment of the charge management controller of FIG. 5A within a housing; and

FIG. 6 illustrates an embodiment of a vibration source useable with the PVTD of FIG. 1.

### DETAILED DESCRIPTION

A point vibration therapy device (“PVTD”) of the present disclosure is designed to provide vibration therapy or stimulation to an individual in need thereof. Illustratively, a PVTD described herein may be used to provide sensory input to an individual to alleviate stimming behavior caused by a sensory dysfunction. The PVTD in one embodiment is a small and unobtrusive device that an individual can attach to a body part, such as a wrist or an ankle, to provide vibrational stimulation in an inconspicuous manner. Further, the PVTD in one embodiment is adjustable; for example, the frequency and duration of the vibration can be modified for optimal effect on a user. In one exemplary embodiment, the PVTD is powered with a rechargeable battery that can provide continuous power to the device for a long period of time, (for example: eight hours) and can be quickly recharged, e.g., within less than ten hours. In addition, the PVTD in one embodiment is easily controlled by a user and also is designed for safety while being durable. Further, the PVTD in one embodiment disclosed herein can be manufactured at a relatively low cost and, thus, provided to a wide range of users in need of such a therapy device.

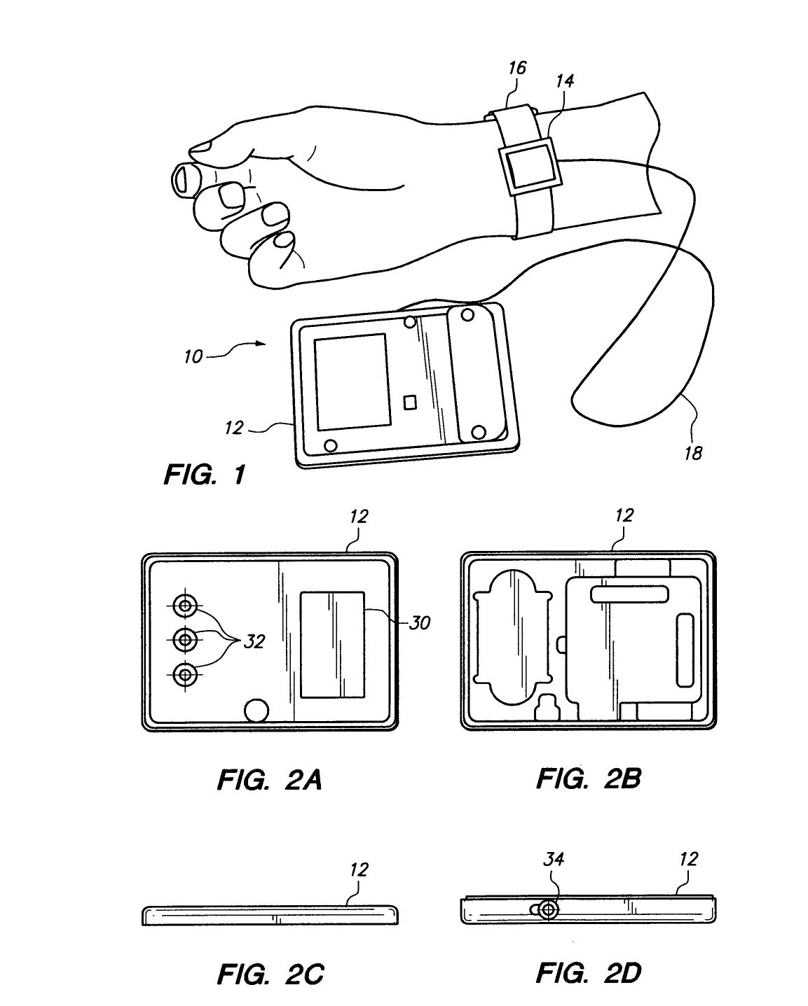

Referring generally to FIGS. 1-6, a PVTD 10 includes a housing and attachment subsystem, a control subsystem, and a power subsystem. The housing and attachment subsystem serves to protect all of the internal components of the PVTD 10 and to affix the device 10 to a user. In one exemplary embodiment, the housing and attachment subsystem is designed without any sharp edges, is manufactured from plastic or other suitable material to reduce the possibility of burns if the device 10 overheats, and is substantially water-resistant or waterproof to protect the device 10 from water damage and to prevent electrical shock of the user. The PVTD 10 of FIG. 1 is a small, unobtrusive device that can be attached and adjusted by a user without any assistance. Further, controls for the PVTD 10 are located on the housing and attachment subsystem for easy access by the user.

The housing and attachment subsystem includes a control circuit housing 12, a vibration source housing 14, and an attachment device 16. Generally, the control circuit housing 12 includes suitable hardware and software components to control the vibration of a vibration source or motor and can be placed in a pocket, backpack, fanny pack, etc. Further, the vibration source housing 14 includes a vibration source to provide vibrational stimulation to a user and the attachment device 16 maintains the vibration source housing 14 in direct contact with the user. One or more wires 18 can connect the control circuit housing 12 to the vibration source housing 14, wherein power and control signals can be sent through the wires to the vibration source housing 14. In other embodiments, a wireless connection can be used to send control signals to the vibration source housing 14, and the vibration source housing 14 may include an independent power source.

In FIG. 1, the attachment device 16 is a strap that is used to attach the vibration source housing 14 to a user. In the exemplary embodiment shown, the strap is made from a soft material for a user's comfort and includes Velcro® to attach and maintain the vibration source housing 14 in direct contact with the user. However, in other embodiments, the attachment device 16 may include adhesives, buckles, or any other suitable mechanism or substance to maintain the vibration source housing 14 in direct contact with a user. In one embodiment, the attachment device 16 is adjustable so that the vibration source housing 14 can be attached to body parts of different shapes and sizes.

Referring to FIGS. 2A-2D, the control circuit housing 12 generally includes a portion 30 through which a display screen can be viewed, various buttons 32 to receive inputs, and an I/O interface 34, as will be described in more detail below. In the exemplary embodiment shown in FIGS. 2A-2D, the control circuit housing 12 may be a generally rectangular structure with dimensions of about 4 inches by about 2.87 inches by about 0.68 inches. The buttons 32 and the I/O interface 34 may be sealed with rubber gaskets or plugs (not shown) to maintain a water-resistant barrier while maintaining functionality of the device 10. The control circuit housing 12 itself can be manufactured by any known technique, for example, using a computer numeric controlled mill that utilizes software, such as SurfCAM, in combination with imported SolidWorks design files.

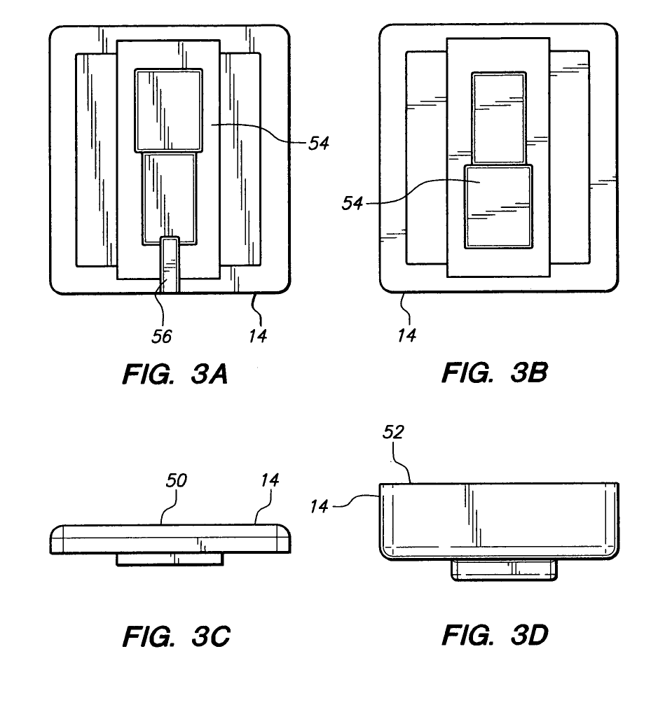

In FIGS. 3A-3D, the vibration source housing 14 includes an upper portion 50 and a lower portion 52, wherein a vibration motor or source 54 is housed therebetween. The vibration source housing 14 further includes a power control connection 56 through which power and control signals are supplied to the vibration source 54. By way of illustration in the exemplary embodiment shown in FIGS. 3A-3D, the vibration source housing 14 may be a generally rectangular structure with dimensions of about 1 inch by about 0.88 inches by about 0.46 inches. The power control connection 56 may be sealed using epoxy or a similar substance to create a water-resistant barrier. Further, the upper and lower portions 50, 52, respectively, can be designed to engage each other by way of a press fit or other known methods. In one embodiment, contacting surfaces of the upper and lower portions 50, 52, respectively, of the vibration source housing 14 are coated with epoxy to seal the vibration source 54 within the housing 14. The vibration source housing 14 may be manufactured using an injection molding process or any other suitable technique.

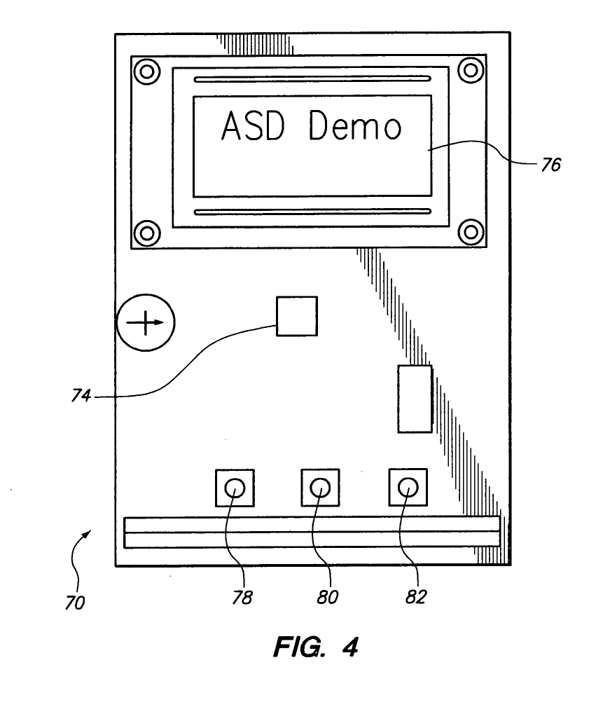

In one embodiment, the control circuit housing 12 houses a control system 70 and a power subsystem 72. FIG. 4 illustrates an exemplary embodiment of the control system 70 that is implemented as an evaluation board. However, in another embodiment, the control system 70 can be implemented as a printed circuit board. The control system 70 of FIG. 4 includes a microcontroller 74, a display screen 76, and first, second, and third inputs, 78, 80, and 82, respectively. In one example, the microcontroller 74 is a M16C/26A microcontroller provided by Renesas Technology of San Jose, Calif. However, in other embodiments, any other suitable microcontroller may be used. The microcontroller 74 is responsive to signals from the inputs 78-82 to operate the device 10. By way of a non-limiting example, the first input 78 provides an “on” function, the second input 80 provides an “off” function, and the third input 82 provides a “toggle” function. Pressing the first input 78 directs the microcontroller 74 to send signals to the vibration source 54 to begin vibrating for a given duration, intensity, and frequency. If the third button 82 is pressed at any time, the duration, intensity, and frequency of the vibration will be changed to different preset values. The different preset values can be modified by programming the microcontroller 70, such as with an external device (not shown) connected to the microcontroller 70 through the I/O interface 34 or any other appropriate method. Pressing the second input 80 at any time will stop the vibration until the first input 78 is pressed again. In another embodiment, the microcontroller 74 can also include a reset input (not shown) that, when pressed, will override the other inputs 78-82 and turn the PVTD 10 off. The inputs 78-82 may be implemented as switches, buttons, resistive or capacitive touch screens or any other input interface as would be known to one skilled in the art.

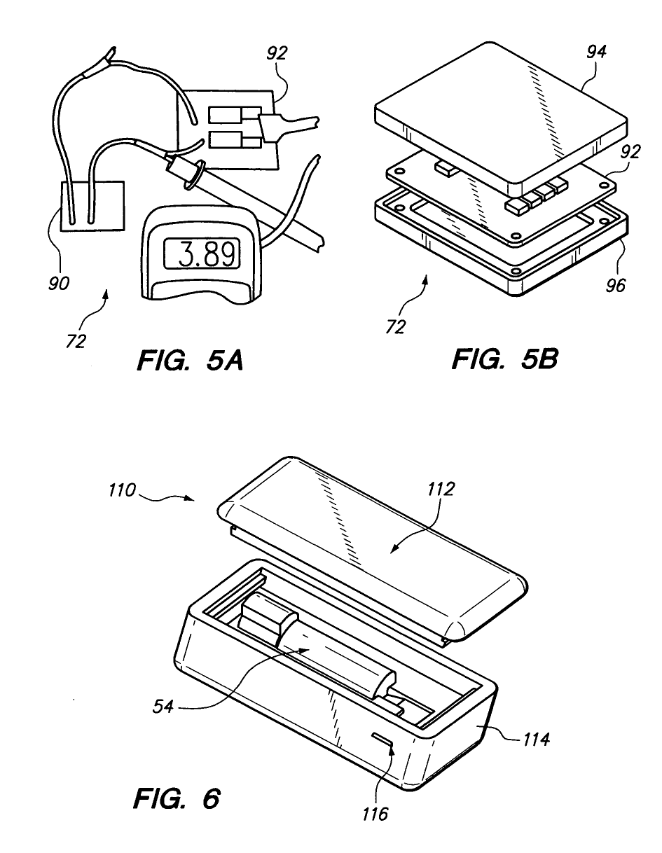

FIGS. 5A and 5B illustrate an example of the power subsystem 72 that supplies voltage required to operate the microcontroller 74, the vibration source 54, and other electrical components. The power subsystem 72 includes a battery 90 and a charge management controller 92. In one example, the battery 90 is a lithium-ion rechargeable battery and the charge management controller 92 is an MCP73863 chip supplied by Microchip Technology Inc., of Chandler, Ariz. The power subsystem 72 also includes a voltage regulator (not shown), as would be apparent to one of ordinary skill in the art. In one embodiment, the charge management controller 92 incorporates the voltage regulator. The voltage regulator takes the output of the battery 90 and generates a supply voltage to power the various components of the device 10. As the battery 90 is drained, the supply voltage is maintained, by way of example in the exemplary embodiment, around 3.3V. Once the battery 90 is depleted, it can be recharged via the charge management controller 92, which can be coupled to an external power supply, for example, an AC power outlet. In one embodiment, the charge management controller 92 can be coupled to an external power supply via the I/O interface 34. In one embodiment, when the battery voltage is below a certain threshold, the battery 90 is preconditioned with a trickle-charge, wherein the charging current supplied to the battery 90 is approximately 10% of the maximum charging current. When the battery voltage exceeds the preconditioning threshold, the current will be regulated at a constant value. The battery voltage increases most quickly during this stage of a charging cycle. Once the battery voltage reaches a regulation voltage, the constant current regulation ends and a constant voltage regulation begins, wherein the current through the battery 90 decreases until it reaches a final threshold. The charging cycle then stops to prevent the battery 90 from overcharging. Modifications to the charging cycle can be made as would be apparent to one of ordinary skill. Further, additional embodiments of the power subsystem 72 may be implemented; for example, the battery 90 can be charged by inductive charging, via a USB connection, or through use of an external transformer connection. Referring to FIG. 5B, the charge management controller 92 can be disposed within a housing that includes an upper portion 94 and a lower portion 96, as would be apparent to one of ordinary skill in the art.

FIG. 6 illustrates an embodiment of a vibration source housing 110, similar to housing 14 as shown in FIGS. 3A-3D, that includes an upper portion 112, a lower portion 114, a vibration motor housed 54 housed therebetween, and a power control connection 116 through which power and control signals are supplied to the vibration source 54. In this exemplary embodiment, the vibration source 54 is a weighted motor. However, in other embodiments, other vibration sources can be used, for example, an electro-diaphragm or an electromagnetic linear motor.

While the embodiment of FIG. 1 includes the control circuit housing 12 and the separate vibration source housing 14, in other embodiments, all of the components of the PVTD 10 may be incorporated into a single housing.

The following table, Table 1, provides a non-limiting list of components that may be used to implement the PVTD 10 described herein.

TABLE 1

Microcontroller and Inputs
M16C/26A Evaluation Board
M16C/26A
(9) 100 kOhm resistors
(2) push button switches, right angle
5 pin DIP switch package
32.768 kHz oscillator
(2) 15 pF capacitors
Debouncing Circuit (Microcontroller Reset)
90.9 kOhm resistor
68 kOhm resistor
1 uF capacitor
Diode
Motor
DC Vibrating Motor
Battery
Kodak 600 mAh Li-lon Battery
Battery contacts
External Connection
Charging connector (barrel)
Cable (barrel jack to wire leads)
Strap and Housing
Velcro strap
Rapid prototyping material (per sq. in)
Acrylic plastic (per sq. in)

The present disclosure is designed to provide vibration therapy at discrete body locations to alleviate patient symptoms. The first identified patient need is for individuals on the autism spectrum. Such individuals often have poor spatial awareness and possess sensory integration disorders resulting in stereotypical stimming behavior, e.g., flailing of limbs, banging their head, etc. The device disclose herein can provide sensory input discretely while the individual with autism participates in a normal daily routine, thereby alleviating the need for stimming. Other individuals that could benefit from the PVTD disclosed herein include, for example, patients suffering from attention deficit disorders or neuropathy.

It is contemplated that the parts and features of any one of the specific embodiments described can be interchanged with the parts and features of any other of the embodiments without departing from the spirit and scope of present disclosure. The foregoing description discloses and describes merely exemplary embodiments of the present disclosure and is not intended to be exhaustive or to limit the disclosure to the precise form disclosed. As will be understood by those skilled in the art, the disclosure may be embodied in other specific forms, or modified or varied in light of the above teachings, without departing from the spirit, novelty or essential characteristics of the present disclosure. Accordingly, the disclosed embodiments are intended to be illustrative, but not limiting, of the scope of the invention, which is set forth in the following claims. The exclusive right to all modifications within the scope of this disclosure is reserved.

What is claimed is:

1. A point vibration therapy device, comprising:
a control system including a control circuit and a plurality of inputs;
a power system including a power source; and
a vibration source system including a vibration source and a plurality of power control connections,
wherein the control system, the power system, and the vibration source system are interconnected.

2. The point vibration therapy device of claim 1, wherein the control system includes a housing.

3. The point vibration therapy device of claim 2, wherein the power system includes a housing and a charge management controller.

4. The point vibration therapy device of claim 3, wherein the vibration source system includes a housing and an attachment device.

5. The point vibration therapy device of claim 4, wherein the control system and the power system are housed together.

6. The point vibration therapy device of claim 5, wherein at least one of the plurality of power control connections of the vibration source system are wires leading to the control system.

7. The point vibration therapy device of claim 1, whereby when at least one of the plurality of inputs of the control system is engaged, a change in the electrical voltage supplied to the vibration source is achieved.

8. The point vibration therapy device of claim 6, wherein the control system housing, the power system housing, and the vibration source housing are water-resistant.

9. The point vibration therapy device of claim 8, wherein the control system includes an I/O interface to provide access to program the control circuit and a display for a user to interact with the point vibration therapy device.

10. A system for point vibration therapy, comprising:
a control circuit;
a plurality of inputs for a user to interact with the system;
a power source; and
a vibration source,
wherein power source powers both the control circuit and the vibration source, and wherein the control circuit controls vibrations received by a user from the vibration source.

11. The system for point vibration therapy of claim 10, further comprising an attachment device for the vibration source to enable the vibration source to be worn on a body of a user.

12. The system for point vibration therapy of claim 11, further comprising a power management controller.

13. The system for point vibration therapy of claim 12, wherein the power management controller is connected between the power source and the control circuit.

14. The system for point vibration therapy of claim 12, wherein the control circuit and power source are contained in a housing, and wherein the vibration source is contained in a separate housing.

15. The system for point vibration therapy of claim 10, wherein the plurality of inputs includes an “on” function, an “off” function, and a “toggle” function.

16. The system for point vibration therapy of claim 12, wherein the control circuit and the vibration source are in communication through a wireless connection.
